(19) United States
(12) Patent Application Publication
(10) Pub. No.: US 2020/0399149 A1
(43) Pub. Date: Dec. 24, 2020

(54) DESALINATION DEVICE

(71) Applicant: Robert Bosch GmbH, Stuttgart (DE)

(72) Inventors: Soo KIM, Cambridge, MA (US); Michael METZGER, Sunnyvale, CA (US); Jonathan MAILOA, Cambridge, MA (US); Mordechai KORNBLUTH, Brighton, MA (US); Georgy SAMSONIDZE, San Francisco, CA (US); Saravanan KUPPAN, Sunnyvale, CA (US); Sondra HELLSTROM, East Palo Alto, CA (US); Boris KOZINSKY, Waban, MA (US); Nathan CRAIG, Santa Clara, CA (US); Jake CHRISTENSEN, Elk Grove, CA (US)

(21) Appl. No.: 16/448,440

(22) Filed: Jun. 21, 2019

(51) Int. Cl. C02F 1/469; B01D 61/48

(52) U.S. Cl. CPC C02F 1/4691; C02F 2103/08; B01D 61/485

(57) ABSTRACT

A desalination battery cell includes a first compartment separated by an anion exchange membrane from a second compartment, each of the first and second compartments configured to contain a saline water solution having a concentration of dissolved salts c₁ and having first and second intercalation host electrodes, respectively, arranged to be in fluid communication with the solution, a voltage source configured to supply electric current to the first and second intercalation host electrodes to release cations into the solution, and a controller programmed to adjust an amount of the electric current being supplied to change direction of anions, present in the solution, passing through the anion exchange membrane between the first and second compartments such that the first and second compartments alternately collect and disperse salt from the solution and the first and second compartments release desalinated water solution having a concentration c₂ of dissolved salts and a brine solution having a concentration c₃ of dissolved salts such that c₃>c₁>c₂.

### TECHNICAL FIELD

The disclosure is directed to a desalination device including one or more desalination battery cells and a method of water desalination using the device.

### BACKGROUND

There is an ever-growing need for quality drinking water. Yet, sources of fresh water on land are limited, some are being depleted, and water quality of other sources is being compromised by a number of industrial and agricultural processes as well as expansion of cities. Thus, technologies are being developed to obtain fresh water from an abundant water source—sea and ocean water. But sea or saline water contains high concentrations of dissolved salt which renders the water unsuitable for human consumption, agricultural use, or industrial processes. Thus, the saline water requires further desalination to lower its concentration of dissolved solids before it can be utilized as drinking water.

Efforts to desalinate water date back thousands of years. For example, first recorded attempts include evaporation of salt water conducted by sailors at sea. The first large-scale modern desalination process, a multi-stage flesh distillation was developed during mid-20^{th} century. Since then, a variety of desalination processes has been proposed and tested. Yet, common problems associated with these processes, which prevent a more widespread use of desalination, include high energy demands, environmental concerns, material issues related to corrosion of membranes, etc.

### SUMMARY

In at least one embodiment, a desalination battery cell is disclosed. The battery cell includes a first compartment separated by an anion exchange membrane from a second compartment, each of the first and second compartments configured to contain a saline water solution having a concentration of dissolved salts c₁ and having first and second intercalation host electrodes, respectively, arranged to be in fluid communication with the solution. The cell also includes a voltage source configured to supply electric current to the first and second intercalation host electrodes to release cations into the solution. The battery cell further includes a controller programmed to adjust an amount of the electric current being supplied to change direction of anions, present in the solution, passing through the anion exchange membrane between the first and second compartments such that the first and second compartments alternately collect and disperse salt from the solution and the first and second compartments release desalinated water solution having a concentration c₂ of dissolved salts and a brine solution having a concentration c₃ of dissolved salts such that c₃>c₁>c₂. Each of the first and second intercalation host electrodes may include a first and second loading of host material, respectively, and the first loading may be different than the first loading. The battery cell may also include an anion exchange membrane dedicated voltage source. The cell may further include at least one inlet channel and at least one outlet channel per each compartment located between the anion exchange membrane and the intercalation host electrode. The battery cell may include a valve configured to prevent flow of a saline water solution to the first or second compartment. The cell may also include an outlet channel and an inlet channel and a first and second reservoir, the second reservoir being connected to the battery via the outlet channel and the inlet channel allowing cycling of the desalinated water solution until a predetermined concentration cₓ of dissolved salts is reached, wherein c₂>cₓ. The cell may have at least one inlet channel and one outlet channel and wherein the controller is configured to adjust volumetric flow rate in the at least one inlet channel, outlet channel, or both. The cell may further have one or more outlet channels, wherein at least one outlet channel may have a lower volumetric flow rate than at least one additional outlet channel.

In another embodiment, a water desalination device is disclosed. The device may include at least two desalination battery cells, each cell having a first compartment separated by an anion exchange membrane from a second compartment, each of the first and second compartments configured to contain a saline water solution having a concentration of dissolved salts c₁ and having first and second intercalation host electrodes, respectively, arranged to be in fluid communication with the solution. The device may further include a voltage source configured to supply electric current to the first and second intercalation host electrodes. The device may also include a controller programmed to adjust an amount of the electric current being supplied from the voltage source to the at least two cells such that the device produces desalinated water solution having a concentration c₂ of dissolved salts and a brine solution having a concentration c₃ of dissolved salts, wherein c₃>c₁>c₂. The device may include a controller programmed to control ion transport in each of the at least two cells individually by supplying a different voltage to each of the at least two cells. The controller may be further programmed to adjust volumetric flow rate of the saline water solution in at least one cell. The at least two cells are connected in series. The at least two cells may be connected parallel to each other. The at least two cells may be arranged in a series-parallel configuration. The at least two cells include first and second cells, the solution enters the first cell with a predetermined volumetric flow rate Q₁ and the controller is programmed to reduce the volumetric flow rate to a volumetric flow rate Q₂ as the solution proceeds to the second cell such that Q₁>Q₂.

In an alternative embodiment, a desalination battery device is disclosed. The device may include a plurality of desalination battery cells arranged in a cascade such that a first row of the cells includes n number of cells, the second row includes at least n+1 number of cells, and each subsequent row includes at least one more cell than a preceding cell row. The device may also have a voltage source configured to supply electric current to the plurality of desalination battery cells. The device may further include a controller programmed to control an amount of the electric current being supplied to the cells such that the device produces desalinated water solution having a predetermined concentration c₂ of dissolved salts and a brine solution having a concentration c₃ of dissolved salts, wherein c₃>c₁>c₂. The volumetric water flow rate in the first row may be greater than a volumetric flow rate in the second row. The second row may include n×2 number of cells and each subsequent row may include two times more cells than a preceding cell row. Each cell may have a dedicated outlet. The device may also include an anion exchange membrane dedicated voltage source.

### BRIEF DESCRIPTION OF THE DRAWINGS

FIG. 1 depicts a schematic diagram of a non-limiting example desalination battery cell according to one or more embodiments;

FIG. 2 shows a schematic diagram of an alternative example of a desalination battery cell;

FIG. 3 schematically shows another alternative desalination battery system;

FIG. 4A shows a schematic depiction of a plurality of desalination battery cells connected in series;

FIG. 4B shows a schematic depiction of a plurality of desalination battery cells connected parallel;

FIG. 4C shows a schematic depiction of a series-parallel configuration of a plurality of desalination battery cells; and

FIG. 5 shows a schematic depiction of cascade arrangement of a plurality of desalination battery cells.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5%, or 10% of the value or relative characteristic.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The Earth's increasing population has an ever-growing need for clean fresh water for consumption, agricultural, and industrial purposes. Fresh water refers to a water solution having a low salt concentration—usually less than 1%. With the fresh water sources being limited, numerous attempts have been made to produce fresh water from abundant sea and ocean waters by desalination. Desalination is a process of removing mineral components from saline water. Removal of salt and other chemicals from the saline water requires electric or thermal energy to separate the saline water into two streams, a fresh water stream containing a low concentration of dissolved salts and a second stream of concentrated brine having a high concentration of dissolved salts.

Various desalination technologies have been developed, for example evaporation, freezing, distillation, reverse osmosis, ion exchange, electrodialysis, and the like. Yet, all of these technologies have certain drawbacks that prevent their wide-spread use and limit their success. For example, reverse osmosis typically requires a large input of electrical energy, which makes this technology quite expensive. Additionally, reverse osmosis utilizes selective membranes which are susceptible to fouling or unwanted accumulation of mineral deposits on the membrane surfaces. The membranes thus need frequent replacement which contributes to maintenance demands and increased cost.

Electrodialysis is another membrane desalination technology implementing ion exchange membranes. Electrodialysis may be costly and does not have a barrier effect against micro bacterial contamination. Yet, membrane-free technologies present other challenges. For example, freeze-thaw typically relies on extended periods of natural sub-zero temperatures and is therefore limited to certain climatic conditions. Multi-effect distillation utilizes several stages or effects during which feed water is heated by steam in tubes onto which saline water is being sprayed. But this technology presents high operating costs unless waste heat is available for the desalination process, and high temperatures may increase corrosion and scale formation.

Among the newly developed concepts are electrochemical approaches to desalination such as a desalination battery or an electrochemical device. Desalination batteries use an electric energy input to extract sodium and chloride ions, as well as other impurity ions from saline water to generate fresh water. The battery thus presents dual-ion electrochemical deionization technology, including sodium and chloride dual-ion electrochemical electrodes to which voltage is applied to bring about separation of saline water into fresh water having a relatively low concentration of dissolved salts and a concentrated brine stream.

It would be desirable to provide a water treatment system utilizing the desalination battery. A non-limiting example of a water treatment system utilizing a desalination battery may include a container to retain a liquid solution such as saline water or desalinated water, two electrodes, a power source, a saline water inlet, and a fresh water outlet. Additional components such as additional inlets, outlets, and the like are contemplated. The two electrodes may be separated by an exchange membrane. The exchange membrane may be either anion or cation exchange membrane. The exchange membrane may include a separator on either or both sides.

The container may be a container, compartment, housing, vessel, can, canister, tank, or the like of any shape, size, or configuration capable of obtaining, retaining, holding, and/or releasing a liquid solution such as saline water, brackish water, sea water, ocean water, fresh water, sweet water, drinking water, desalinated water, contaminated water, industrial water, etc. The container is spacious enough to house a sufficient amount of a water solution undergoing desalination; dimensions thus differ based on a specific application. The container may be large enough to serve industrial applications. The container may be made from different materials capable of withstanding corrosion, temperature fluctuations, changing pH, varying pressure, and be resistant to other chemical, mechanical, and/or physical conditions.

The container may be made me from glass, plastic, composite, metal, ceramic, or a combination of materials. The container may feature one or more protective coatings. The container may be made from a material which will minimize occurrence of water contamination. The container may be made from material(s) which are nontoxic and comply with drinking water standards.

The electrodes are arranged within the battery to be in fluid communication with the water present in the container. The electrodes are at least partially submerged in the water solution. The electrodes may be fully submerged in the water solution. The electrodes may be placed on the opposite sides of a container, placed centrally in the container, or both be located on the same side of the container. The electrodes may be located next to each other or be separated by a distance with the presence of separator(s) and exchange membrane (either anion exchange membrane or cation exchange membrane). The distance may be 1 mm or more, 1 cm or more, 10 cm or more, 20 cm or more, 30 cm or more, depending on the dimensions of the battery module and stack systems, container, and electrodes.

The electrodes of the battery function as intercalation hosts. Intercalation refers to reversible inclusion of one or more ions into materials with layered structures. The spaces between layers may serve as a temporary storage for one or more types of ions. The first and second intercalation hosts reversibly store and release cations and anions from the saline water solution having a first concentration c₁ of dissolved salts to generate a fresh or desalinated water solution having a second concentration c₂ of dissolved salts and a brine solution having a third concentration c₃ of dissolved salts within the container such that c₃>c₁>c₂. Typically, c₁ may be between about 500 to 10,000, 800 to 7,000, or 1,000 to 5,000 ppm of dissolved salts, depending on the saline water source. The battery may reduce the amount of dissolved salts to c₂ of about 15 to 250, 30 to 150, or 50 to 100 ppm.

The electrodes may be made from the same or different material, depending on the operating condition and device design. The first, the second, or both electrodes may be made from expanded graphite. Graphite is a crystalline allotrope of carbon and is an example of a semimetal. Graphite presents the most stable form of carbon under standard conditions. Graphite is an electric conductor with highly anisotropic acoustic and thermal properties and is self-lubricating. Graphite has a layered, planar structure. Graphite's individual layers are called graphene. In each layer, the carbon atoms are configured in a honeycomb lattice with natural separation of 0.142 nm. The interlayer distance of pristine graphite is 0.335 or 0.34 nm. Individual atoms in the plane are bonded covalently, but bonding between graphene layers is provided via weak van der Waals bonds.

Thanks to its unique properties and structure, graphite has been used as an anode electrode material in Li-ion batteries. Yet, the applications typically involve pristine graphite. It is well-known that pristine graphite with its interlayer distance between the graphene layers in z-direction of 0.34 nm is not suitable for a different type of batteries, namely Na-ion batteries (NIB) because pristine graphite has a low capacity for Na⁺ ions. Due to the relatively large size of Na⁺ ions and steric effects, Na⁺ generally has a weaker chemical bonding to pristine graphite than other elements present in the same column of the periodic table, that is other alkali metals. For example, Na⁺ ions have larger radius than Li⁺, which may hinder mass transport of Na⁺ ions during electrochemical processes.

Thus, the electrode may include expanded graphite having an interlayer distance sufficient to accommodate Na⁺ ions. The expanded graphite may be formed by modifying and/or expanding the interlayer distance of the pristine graphene layers. Different methods of expansion may result in an interlayer distance tailored for a specific application. When the graphene layers are expanded such that the expanded graphite interlayer distance is greater than 0.34 nm, specifically to 0.43 nm or more, Na⁺ ions, and/or other ions, may reversibly insert into and extract from the expanded graphite, delivering a relatively high reversible capacity of >−280 mAh/g at the current density of 10 mA/g. By using expanded graphite instead of pristine graphite, the sodium ion storage capacity may thus improve at least about 20 to 30 times.

The interlayer distance of the graphene layers may be tailored to provide sufficient storage capacity for a variety of anions, cations, or both. The interlayer spacing between the graphene layers may be significantly or substantially uniform. The interlayer spacing may be uniform along the entire length of the graphene layers, if well-controlled by the synthesis conditions.

The interlayer distance dₛ between the graphene layers in z-direction in the herein-disclosed expanded graphite may be greater than about 0.34 nm, 0.35 nm, 0.36 nm, 0.37 nm, 0.38 nm, 0.39 nm, 0.40 nm, 0.41 nm, 0.42 nm 0.43 nm, 0.44 nm, 0.45 nm, 0.46 nm, 0.47 nm, 0.48 nm, 0.49 nm, 0.50 nm, 0.51 nm, 0.52 nm, 0.53 nm, 0.54 nm, 0.55 nm, 0.56 nm, 0.57 nm, 0.58 nm, 0.60 nm, 0.61 nm, 0.62 nm, 0.63 nm, 0.64 nm, 0.65 nm, 0.66 nm, 0.67 nm, 0.68 nm, 0.69 nm, 0.70 nm or greater. The interlayer distance dₛ of the expanded graphite may be between about 0.37 and 0.45 nm, about 0.45 nm and 0.6 nm. The interlayer distance dₛ of the expanded graphite may be from about 0.37 to about 0.7 nm, about 0.43 to about 0.6 nm, or about 0.45 to about 0.55 nm. Different oxygen functional groups in the graphene sheets may assist with controlling the interlayer distance dₛ. The oxygen functional groups may include groups such as —OH, ═O, —O—, —COOH, the like, or a combination thereof. The groups may be prepared via solution-based approach and/or heat-treatment that may precisely control the interlayer distance dₛ.

As a result of the expanded interlayer distance, expanded graphite can uptake cations and anions from saline water, seawater, brackish water, or the like. Expanded graphite can uptake cations including, but not limited to Na⁺, Mg²⁺, Al³⁺, Si⁴⁺, K⁺, Ca⁺, Sc³⁺, Ti^{2+/3+/4+}, V^{2+/3+/4+/5+}, Cr^{3+/6+}, Mn^{2+/3+/4+}, Fe^{2+/3+}, Ni^{2+/3+/4+}, Cu²⁺, Zn²⁺, Sn^{2+/4+}, Pb⁴⁺, etc. and anions including, but not limited to, single anion species such as F⁻, Cl⁻, Br⁻, I⁻, S^{-/2-}, anion complexes such as ClO₄⁻, ClO₃⁻, ClO₂⁻, BrO₄⁻, BrO₃⁻, SO₄²⁻, SiO₃²⁻, CN⁻, metal-containing anions such as MX_{y}O_{z}ⁿ⁻ (where M=Na, Mg, Al, Si, K, Ca, Sc, Ti, V, Cr, Mn, Fe, Ni, Cu Zn, Mo, Sn, Cs, and Pb; X═F, Cl, Br, I, N, and P; and 0<y≤5; 0≤z≤5; 1≤n≤4), and the like.

The expanded interlayer distance of the expanded graphite allows even ions with a relatively large radius such as Na⁺ to be drawn within the spaces defined by the graphene layers, temporarily remain therein, and be released later. The expanded graphite thus hosts one or more ions as guests.

The intercalation material may be specialized or tailored for cations or anions, respectively. In such case, the cation intercalation material is capable of capturing and releasing cations only, the anion intercalation material is capable of capturing and releasing anions only. For example, the intercalation material may include one or more of the following materials listed in Table 1 below:

TABLE 1

AₓCuFe(CN)₆, where A = Li, Na, K, Cs and 0 ≤ x ≤ 1
AₓMnFe(CN)₆, where A = Li, Na, K, Cs and 0 ≤ x ≤ 1
AₓMnMn(CN)₆, where A = Li, Na, K, Cs and 0 ≤ x ≤ 1
AₓZnFe(CN)₆, where A = Li, Na, K, Cs and 0 ≤ x ≤ 1
AₓBaFe(CN)₆, where A = Li, Na, K, Cs and 0 ≤ x ≤ 1
TiₓFe₁₋ₓ[Fe(CN)₆]_{0.96}, where 0 ≤ x ≤ 1
Polyimide (PNDIE)
FePO₄
NaMnFe₂(PO₄)₃ Alluaudite
Na₃Fe₃(PO₄)₄
Na(M)PO₄, where M = Fe, Mn, or FeₓMn₁₋ₓ and 0 ≤ x ≤ 1
MnO₂
NaₓMnO₂, where 0 ≤ x ≤ 1
ZnMn₂O₄
MgFeSiO₄/C
MgₓMn₂₋ₓSiO₄, where 0 ≤ x ≤ 2
Mg_{0.5}Ti₂(PO₄)₃
LiTi₂(PO₄)₃
TiₓAl₂₋ₓ(PO₄)₃, where 0 ≤ x ≤ 2
TiP₂O₇
Na₃MnTi(PO₄)₃
K₂Ti₄O₉
TiS₂
FeS₂
CaMO₃, where M = Mn and/or Fe
Potassium Terephthalate
2,5-pyridinedicarboxylate (K₂PC)
KFeF₃
K_{0.3}MnO₂
KMgₓFe₂₋ₓ(PO₄)₂, where 0 ≤ x ≤ 2
AₓFeFe(CN)₆, where A = Li, Na, K, Cs and 0 ≤ x ≤ 1
AₓNiFe(CN)₆, where A = Li, Na, K, Cs and 0 ≤ x ≤ 1
NaTi₂(PO₄)₃
Na₂FeP₂O₇
TiO₂
Na₂Ti₃O₇

The cation intercalation material may be doped or un-doped cubic spinel MnO₂, Na₄Mn₉O₁₈ (or equivalently, Na_{0.44}MnO₂) tunnel structured orthorhombic materials, NaM₂(PO₄)₃ (where M=Ti, Mn, Fe, Ni, Cu, or combinations thereof), where the exact composition of Na may be controlled by thoroughly mixing different starting amount of Na₂CO₃ or NaOH with metal oxide precursors, followed by the heat treatment at high temperature (about 800° C.). Partial substitution of Na in these structures with Li, Mg, Ca, and/or K is allowed.

Additionally, the cation intercalation material to be used as an electrode may include, but is not limited to, Na_{0.44}Mn₂O₄, NaMnO₂, Ko₂₇MnO₂, Na_{2/3}Ni_{1/4}Mn_{3/4}O₂, γ-MnO₂, Na₃V₂(PO₄)₃, Na₂VTi(PO₄)₃, NaVPO₄F, Na₂V₆O₁₀.xH₂O, Na_{0.66}[Mn_{0.66}Ti_{0.34}]O₂, MoO₃, Na₂FeP₂O₇, Na₃TiMn(PO₄)₃, Na₃V₂O₂(PO₄)₂F, the like, or a combination thereof. The cation intercalation host material may include Prussian blue and/or Prussian blue analog—hexacyanoferrate (HCF) or hexacyanomanganate (HCM)-based compounds such as NiHCF, NiCuHCF, and MnHCM.

On the other hand, the intercalation material may be specialized for anions. The anion intercalation material may include AgCl, FeCl₃, C₃N₄, FeOCl, BiOCl, VOCl, Mg(ClO₂)₂.6H₂O, MgCl₂O, NaClO₂.3H₂O, at least one of the following ternary and quaternary metal oxides and metal oxychlorides: AlH₁₂(ClO₂)₃, MnH₈(ClO₂)₂, FeH₈(ClO₂)₂, and NiH₈(ClO₂)₂, at least one of the following alkali-metal-based and transition-metal-based oxychlorides and their hydrates: Ca₄Cl₆O, CaHClO, NaH₄ClO₂, AlClO, Si₃(Cl₄O)₂, SiCl₂O, Si₆Cl₁₀O₇, SiCl₂O, Si₂Cl₂O₃, Ti(ClO₄)₄, TiClO, Mn₈Cl₃O₁₀, MnH₄(ClO)₂, FeClO, Ni(ClO₄)₂, NiHi₆(ClO₈)₂, NiH₁₂(ClO₃)₂, Cu₂Cl₂O, and CuH₈(ClO₅)₂, the like, or a combination thereof.

An example loading amount of the active material capable of intercalation may be about 0.01 to 100 mg/cm², 0.05 to 50 mg/cm², or 0.1 to 10 mg/cm² in the cathode, anode, or both.

Besides the active material, one of the electrodes or both may include one or more conductivity agents, one or more polymeric binders, and/or other components. The electrode(s) may include active material in the amount of about 70 to 99 wt. %, 75 to 97 wt. %, or 60 to 95 wt. %, based on the total weight of the electrode. The electrode(s) may include one or more conductivity agents in the amount of about 1 to 40 wt. %, 2.5 to 30 wt. %, or 5 to 20 wt. %, based on the total weight of the electrode. The electrode(s) may include one or more polymeric binders in the amount of about 1 to 30 wt. %, 2.5 to 20 wt. %, or 5 to 15 wt. %.

A non-limiting example of a conductivity agent may include carbon black, conductive carbon black, amorphous carbon, carbon fibers, quaternary ammonium salt(s), alkyl sulfonate(s), halogen-free cationic compound(s), the like, or a combination thereof.

A non-limiting example of a polymeric binder may be polyvinylidene fluoride (PVdF), polyacrylonitrile (PAN), poly(methyl methacrylate) (PMMA), polyethylene glycol (PEO), polyimide, polydopamine, poly(ethylene glycol) diacrylate, polymethylpentene, nylon, metal-aramid, polyether imide, copolyester, polyetherketone, carboxymethyl cellulose, styrene-butadiene rubber (SBR), copolymers and blends such as poly(vinylidenefluoride-hexafluoropropylene) (PVdF-HFP), poly(vinylidenefluoride-chlrotrifluoroethylene) (PVdF-CTFE), poly(methyl methacrylate-vinyl acetate) (PMMA-VAc), poly(ethylene glycol) diacrylate (PEGDA), poly(methyl methacrylate-acrylonitrile-vinyl acetate) (PMMA-AN-VAc), poly(methyl methacrylate-co-butyl acrylate) (PMMA-co-BA), poly(3,4-ethylenedioxythiophene) polystyrene sulfonate-co-polyethylene glycol (PEDOT-co-PEG), the like, or a combination thereof.

Additionally, the electrode(s) may include one or more pillaring agents. Pillaring agents or dopants refer to various compounds which may be incorporated within the structure of the electrode by chemical modification of the active material. For example, the pillaring agents may be chemically and/or mechanically bonded to the individual graphene layers of the expanded graphite. The one or more pillaring agents may be incorporated between adjacent graphene layers within the expanded graphite and/or configured to maintain a predetermined, specific interlayer spacing distance dₛ between the adjacent layers.

The pillaring agents may further enhance the mass transport and/or selectivity of ion adsorption and desorption processes in the battery. For example, incorporating sulfur as a pillaring agent may result in attracting a larger proportion of cations. Alternatively, modifying the electrode active material with positive metal or metal oxides may result in an increased attraction of anions while repelling cations. The pillaring agents may thus assist with adjusting chemistry of the fresh water solution to achieve a desirable chemical composition of drinking water. For example, in a region where the seawater to be desalinated contains an undesirable amount of anions and/or desirable amount of cations, a positive pillaring agent may be incorporated to attract the anions to be intercalated while leaving a greater amount of cations in the water solution. The fresh water solution may thus be tailored to the local needs and drinking water norms.

The electrodes may operate within the water stability window, about −0.5 to 1.5 V, −0.4 to 1.2 V, −0.3 to 1.1 V, or 0 to 0.9 V in comparison to standard hydrogen electrode (SHE) (or, 2.2 to 3.6 V vs. Na/Na⁺ to store one or more of the above-mentioned types of ions, for neutral water at pH of about 7-8. Lower pH value can shift the voltage higher (up to +0.4 V at pH=0) and higher pH value can shift the voltage lower (up to −0.4 V at pH=14).

The actual storage capacity of ions in the electrodes may vary depending on the operating voltage conditions, concentration of ions present in the water solution, overall chemical composition of the water solution, acidity of the water solution, and ohmic or any other type of resistance within the battery device, etc. For example, the actual capacity of ions in the electrodes may differ based on location as seawaters in different parts of the world have varying ion concentrations.

The salt adsorption capacity of the electrodes may vary from about 1 to 300, 5 to 150, or 10 to 100 mg salt/g of active electrode materials. The electrode area may vary from about 10 to 500, 50 to 350, or 100 to 250 cm². The electrode thickness may vary from about 2.5 to 500, 5 to 400, or 10 to 300 μm, depending on the choice of electrode materials, porosity, tortuosity, viscosity of slurry containing the electrode materials, and the actual composition ratio of active materials:binder:carbon. The porosity of electrodes may be about 20 to 80, 30 to 70, or 40 to 60%. The electrode density may vary from 0.1 to 5, 0.25 to 4, or 0.5 to 3 g/cm³, depending on the particle size, microstructure, hardness of materials, as well as the amount of additive carbon in the electrode system.

The charge time for the battery for water cleaning may be from about 1 to 60 minutes, 5 to 45 minutes, or 15 to 30 minutes, depending on the capacity. The discharge time for electrode cleaning may take about 50 to 100% of the charge time, that is about 30 seconds to 60 minutes, 2.5 to 45 minutes, or 7.5 to 30 minutes. Typical flow rate during the charge process range may be about 0.5 to 5000 L/minute, 1 to 2500 L/minute, or 5 to 2000 L/minute, depending on a number of cells included in the battery module. The recovery rate of water may be greater than about 50, 55, 60, 65, 70, 75, 80, 85, 90, or 95%. The exact water flow rate may be controlled by the pumps as discussed below.

The electrodes may be separated by an exchange membrane. The exchange membrane may include a separator on either or both sides. The exchange membrane may be a cation or anion exchange membrane.

The exchange membrane may be an anion exchange membrane (AEM). The AEM may include graphene, graphene oxides, or both composed of hydroxyl-rich (—OH) oxygen functional groups. Specific functional groups such as hydroxyl (—OH), carboxylic (—COOH), carbonyl (═O), epoxy (—O), or a combination thereof, in graphene oxides allow adsorption and desorption of cations (i.e., Na⁺, K⁺, Mg²⁺, Ca²⁺, Pb²⁺, etc.) at a relative stable voltage window such as 1.0 to 1.5 V or 0.401 to +1.23 V vs. SHE. In contrast, the anion absorption voltage is very high due to the electronic repulsion between the anion itself and graphene oxides oxygen functional groups (—OH, —COOH, ═O, and —O—). Unless a very large voltage, greater than 3 V, is applied to the system, the anions such as F⁻, Cl⁻, Br⁻, I⁻, or S²⁻, and anion complexes, including but not limited to, ClO₄⁻, ClO₃⁻, ClO₂⁻, BrO₄⁻, BrO₃⁻, SO₄²⁻, SiO₃²⁻, or CN⁻ freely move to the other side of the membrane because of the repulsion by the negatively-charged oxygen functional groups in the AEM materials. Thus, the functionalized graphene oxide layer can be used as a selective ion exchange membrane that only allows anions to pass.

The AEM may include a mixture of graphene oxides and other electronically conductive polymers including polyethylene oxide (PEO), poly(pyrrole)s (PPY), polyanilines (PANT), poly(thiophene)s (PT), poly(3,4-ethylenedioxythiophene) (PEDOT), poly(p-phenylene sulfide) (PPS), poly(acetylene)s (PAC), and poly(p-phenylene vinylene) (PPV), the like, or a combination thereof. In addition, the AEM may be composed of a mixture of graphene oxides and other polymers that are not electronically conductive but are ionically conductive including cross-linked poly-vinyl alcohol (PVA), cross-linked polymethylmethacrylate (PMMA), polyphenylene vinylene (PPV), the like, or a combination thereof. Additional electronically conductive material can be added as needed, such as graphite, hard carbon, soft carbon, carbon black, the like, or a combination thereof.

The battery or capacitive de-ionization device further contains a power source, current source, or voltage source capable of supplying electric current to the electrodes and/or the exchange membrane. The electric current is being applied to remove various ions from the water contained in the container. Applied voltage V and membrane voltage Vm may be used to control selective ion permeability and influence overall efficiency of the water desalination process. The electric current may be constant current until reaching a predetermined voltage cutoff or positive voltage may be applied to the battery. Cation entrapment and anion diffusivity thought the exchange membrane may be enhanced by applying a controlled membrane voltage Vm. The membrane voltage may be about 0 to ±0.5 V.

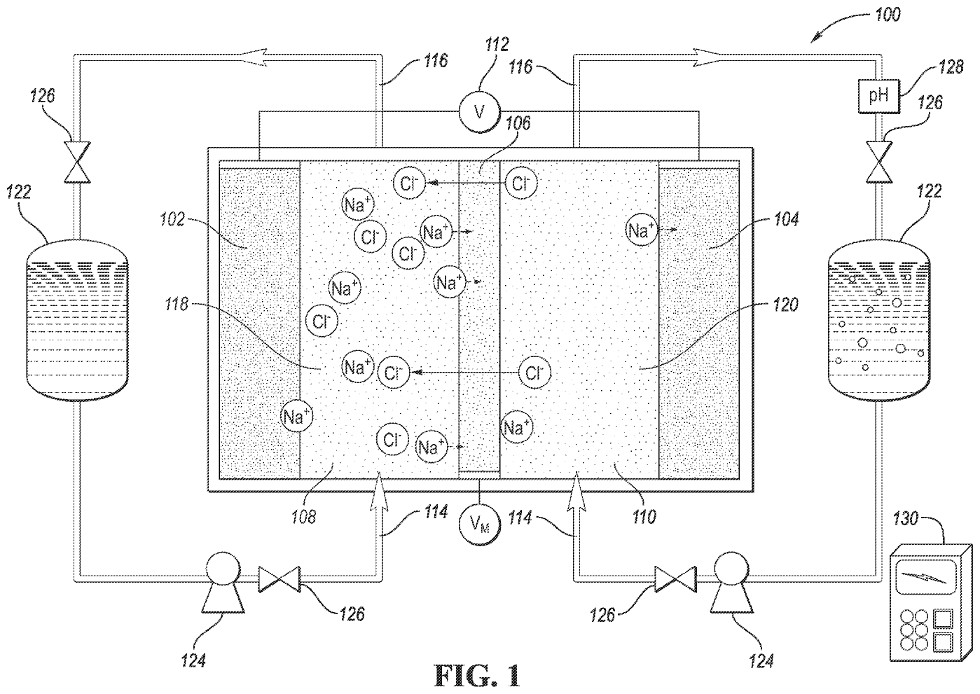

A non-limiting example battery cell 100 for use in a water treatment device is depicted in FIG. 1. The battery 100 includes two electrodes 102 and 104 and an anion exchange membrane 106 placed between the electrodes 102, 104. The exchange membrane 106 separates two independent water compartments 108, 110. The electrodes 102, 104 are connected to a voltage source 112. The battery cell 100 also includes one or more water inlets 114 and water outlets 116.

The inlets 114 and outlets 116 may be used to bring in or release saline or desalinated water. The number of inlets 114 and outlets 116 per compartment 108, 110 may be the same or different. For example, a first compartment 108 may have one more inlet than the second compartment 110. One or more inlets 114 may be located between the AEM 106 and the intercalation host 102, 104. An inlet 114, an outlet 114, or both may be located centrally between the AEM 106 and the host electrodes 102, 104. An inlet 114 may be located directly across from an outlet 116. Alternatively, an inlet 114 and an outlet 116 of the same compartment 108 or 110 may be staggered such that the inlet 114 and the outlet 116 are not aligned, are not placed on the same axis. The at least one inlet 114, outlet 116 or both may have the same or different diameter. An inlet 114, an outlet 116, or both may connect the battery 100 with the reservoir 222, reservoir 223, or both.

In addition, the battery cell 100 and additional battery cells disclosed herein may be connected to one or more water reservoirs 122 for storing saline or desalinated water, one or more pumps 124 capable of controlling water flow rate to from the battery 100, valves 126 connected to the one or more pumps 124, and/or one or more devices 128 capable of checking, determining, or monitoring water quality such as a pH meter, water softener, etc. The reservoir 122 may be a container, compartment, housing, vessel, can, canister, tank, or the like of any shape, size, or configuration capable of obtaining, retaining, holding, and/or releasing a liquid solution such as saline water, brackish water, sea water, ocean water, fresh water, sweet water, drinking water, contaminated water, industrial water, etc. The pumps 124 may be automatic, manual, or both. The pumps 124 may be located in the inlet, outlet pipes, a stream connected to a water reservoir 122, or a combination thereof.

Alternatively or in addition, a post-treatment step may be carried out to further neutralize/adjust the water as required by a specific application.

The battery cell 100 may include two symmetrical electrodes 102, 104 including the same or similar chemistry and loading of the electrode material. Alternatively, the battery 100 may feature an asymmetric electrode configuration such that a first electrode 104 is made at least partially or entirely from a different material than the second electrode 106. The electrode materials may share similar structural characteristics such as same space group, but the concentration of ions such as Na⁺, Ca²⁺, or Mg⁺ may differ.

The battery cell 100 may be run in the following manner. A positive voltage V may be applied to the battery cell 100 to release cations such as Na⁺ from one of the electrodes 102, 104. The cations are dispersed with the saline water in one of the water compartments 108, 110, specifically the brine compartment 118 including the saline water solution having a first concentration c₁ of dissolved salts. The saline water in the brine compartment 118 may be supplied through one of the water inlets 114. As cations cannot travel through the anion exchange membrane 106, the concentration of Na⁺ in the brine compartment 118 increases. Anions such as Cl⁻ become attracted and travel through the anion exchange membrane 106 to neutralize the cations in the brine compartment 118. At the same time, cations such as Na⁺ ion intercalate into the other side of the electrodes 102, 104 due to charge neutrality and the applied voltage bias. This process creates a clean water compartment 120 including a fresh or desalinated water solution having a second concentration c₂ of dissolved salts on the opposite side of the anion exchange membrane 106 such that c₁>c₂.

The battery 100 may operate in cycles (intercalation and de-intercalation), where the water flows continuously. Under the continuous flow, the desalinated water from the clean water compartment 120 may be stored in a reservoir 122. Alternatively, the battery 100 may operate as a batch desalination device, where a limited amount of water may be supplied to a compartment to be cleaned in a smaller scale operation. Alternatively, or in addition, a semi-continuous flow of water may be supplied to the battery cell 100 such that the water compartments 108, 100 may be refilled with additional saline water and may operate in the reverse direction in the next cycle. In an alternative embodiment, the battery cell 100 may be designed as a cylindrical tubular cell. Both compartments 108, 100 may be used for water purification in reverse operating direction.

In a non-limiting example, a continuous collection of clean water in successive cycles may be provided by utilizing a clean water reservoir 122 and a recycling loop for water purification. During the start-up, two electrodes 102, 104 are at similar state-of-charge (for example 50%), then the first electrode 102 is discharged (toward 0%) and the second electrode 104 is charged toward 100% SOC. In the first cycle, the first target ions including Na⁺, K⁺, Mg²⁺, Ca²⁺, and Pb²⁺, and the like may be removed from the electrodes 102, 104 including the intercalation host material. Anions are added to the brine compartment 118 due to the cation-anion attraction (neutrality). The clean water compartment 120 thus contains desalinated water that may be collected. The next cycle allows to flush ions out of the electrodes 102, 104, expelling waste water. The electrodes 102, 104 may be also available for the next water purification cycle.

The desalinated water may be cycled in the battery 100 one or more times to further purify the water to reach a predetermined concentration cₓ of dissolves salts such that cₓ>c₂.

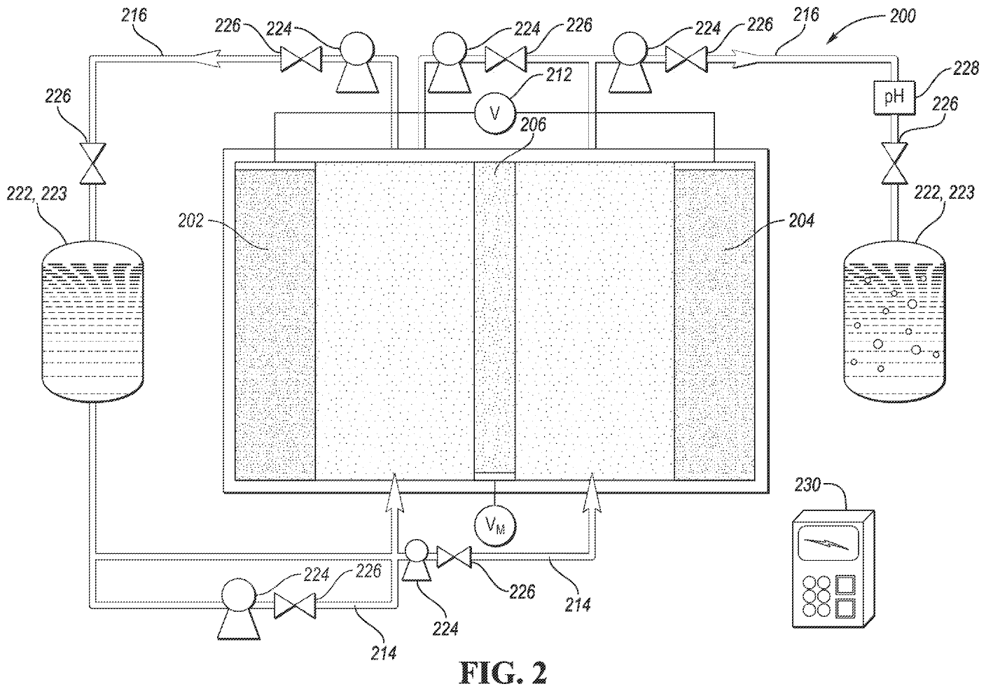

In an alternative embodiment depicted in FIG. 2, a desalination battery cell 200 is shown. The battery cell 200 has asymmetrical electrodes 202, 204 having different type of intercalation material, loading of intercalation material, or both. For example, the starting concentration of alkali metal within the alkali metal oxide may be different in the anode and cathode (change in x for NaₓMO_{y}). Depending on the type of material used and the loading, the operating voltage may be adjusted. Because different intercalation materials may have a different state of charge (SOC) from the start, the start-up time for activating electrodes may be reduced.

The battery cell 200 further includes an ion exchange membrane 206, water compartments 208, 210, a voltage source 212, water inlets 214 and water outlet 216, water reservoirs 222, pumps 124, valves 126, additional devices 128 such as a pH monitoring device, and water inlets 214 and outlets 216 similar to the embodiment of FIG. 1.

Instead of a specifically dedicated “brine” and “clean” water compartments, the battery's both compartments 208, 210 may be used to output desalinated water in alternate cycling step. Voltage may be controlled to change the direction of the anions passing through the anion exchange membrane 206. Therefore, both compartments 208, 210 are directly connected to a brine water reservoir 223 to collect and/or disperse salt, and also to the clean water stream and tank reservoir 222, enabling to output purified water alternately. Each compartment 208, 210 may thus serve as a brine compartment or clean water compartment. The alternate cycling of the battery cell 200 has the advantage of not requiring a discharging step.

After a number of purification cycling processes, a purging step may be required to clean the compartments, inlet pipes, outlet pipes, or a combination thereof to remove possible salt build-up residues and to regenerate the electrodes within the battery cell 200.

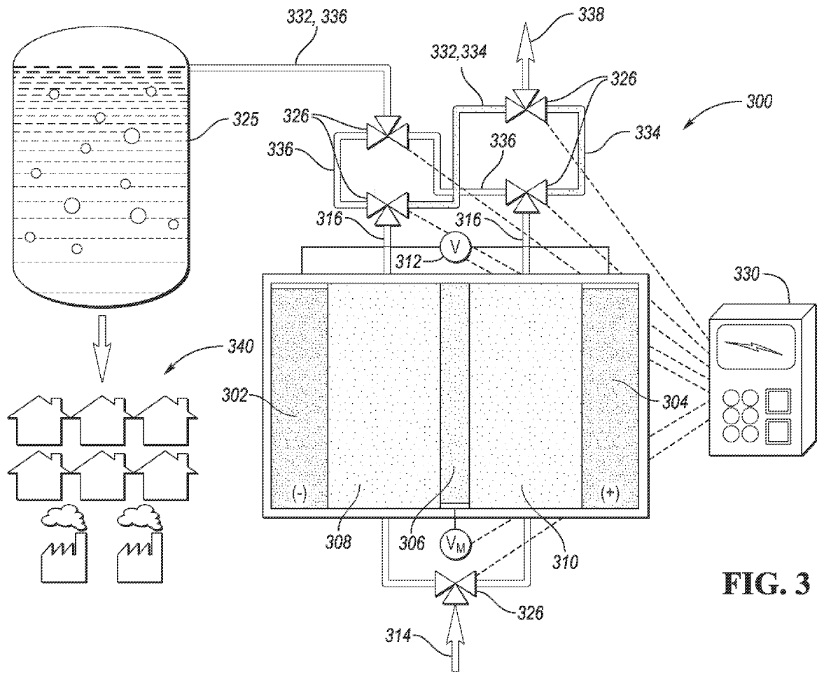

In a yet another embodiment depicted in FIG. 3, the battery system 301 may be connected to a control unit 330. The control unit 330 may include one or more controllers 330 programmed to control, manage, and/or alter voltage, membrane voltage, electric current, relative flow rates in individual inlet/outlet channels, in the entire system, or both, input water volume, output water volume, frequency, duration, or both of a recharge or purge cycle, degree of water desalination, cleaning modalities used in the process, etc. For example, the controller 330 may be programmed to supply a different external voltage to each cell 401 or group of cells 401 to precisely control the ion transport in each cell 401. Additionally, the controller 330 may be programmed to adjust volumetric flow rate to each cell 401 or groups of cells 401 as described below to maximize water purification performance by increasing residence time of the water being desalinated within the system 400.

The one or more controllers 330 have one or more processing components such as one or more microprocessor units (not depicted) which enable the controllers 330 to process input data. The input data may be supplied from the sensors (not depicted) and/or a computer system (not depicted) connected to the controllers 330. The input data supplied by the computer system may include a variety of data such as supply, demand data, physical and chemical properties of the input water, physical and chemical properties of the electrodes and the ion exchange membrane, state of the electrodes, voltage to be applied, duration of each cycle, flow rate data, predetermined desalination values, etc. The data may be supplied to the controller 330 prior to the desalination process, during the process, or both.

In a non-limiting example of FIG. 3, the battery cell 300 includes electrodes 302, 304 and an ion exchange membrane 306 dividing the electrodes 302, 304. The battery cell 300 includes two compartments 308, 310, and a power source 312 supplying voltage to the electrodes 302, 304 and to the membrane 306. The saline water is provided via a water inlet 314, which is led to the compartments 308, 310 via a three-way valve 326. The desalinated water is released from the one or both compartments 308, 310 via outlets 316.

The inlet(s) 314 and/or outlet(s) 316 may include one or more channels or lines 332. At least some of the channels 332 may serve as salt collection channels 334 having lower water flow than the remainder of the system 300 during operation of the system 300. The system 300 may further include one or more treated water channels 336 capable of delivering treated, desalinated, or clean water to one or more consumers, possibly via a clean water reservoir 325. The battery cell 300 further includes a number of valves 326, which allow reverse water flow, emergency drainage, or both.

During a purging step, a residential or industrial consumer 340 may draw clean or treated water from the clean water reservoir 325 while the valves 326 to/from one or more clean channels 336 are closed. One or more salt collection channels 334 may be purged to a waste stream 338 or a brine water reservoir (not depicted). After purging, the current direction may be switched, the valves 326 to/from one or more clean channels 336 may be opened, and desalination process may be repeated.

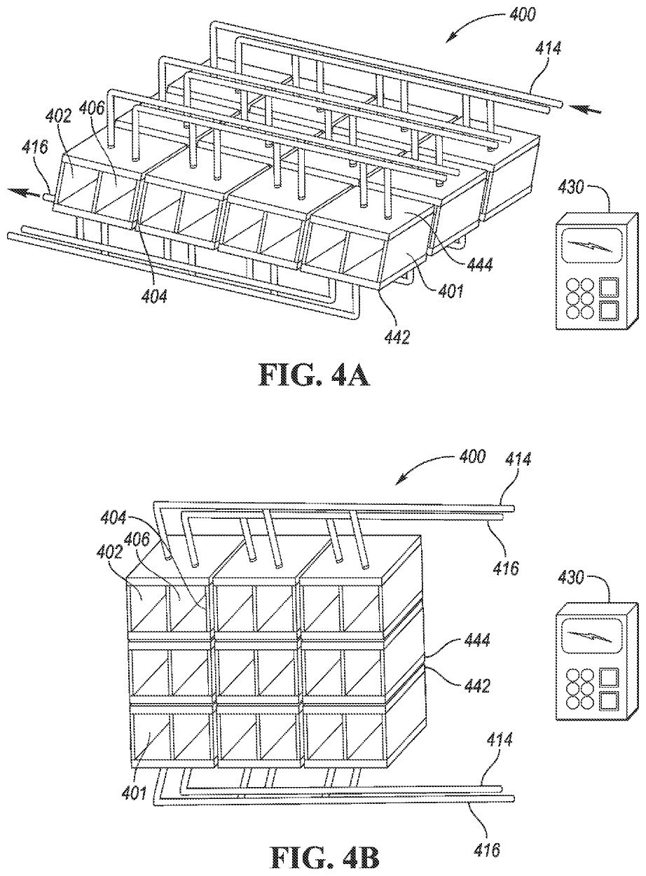

The desalination/water treatment systems disclosed herein may provide water to a variety of consumers such as residential, industrial, or power plants. Depending on an application size, battery cell units such as those depicted in FIGS. 1-3 may be combined, freely stacked, and connected to create a larger system. Non-limiting examples of large-scale water desalination battery or water treatment or water desalination systems are depicted in FIGS. 4A-4C.

For example, a system 400 may include at least two or two or more battery cell units 401, which may be connected in series such as depicted in FIG. 4A, parallel, depicted in FIG. 4B, or series-parallel configuration such as depicted in FIG. 4C. In the series or parallel configurations of FIGS. 4A and 4B, a single cell 401 may include an anode 402, an exchange membrane 406, and a cathode 404. In the configuration of FIG. 4C, a single cell 401 may include an anode 402, a membrane 406, a cathode 404, a membrane 406, an anode 402, etc. allowing continuous water flow and step-by-step cleaning within the system 400. Different arrangements of the cells 401 within the system 400 offer different advantages. For example, connection of the cells 401 in series may result in a higher degree of desalination as the same water proceeds through a higher number of purification steps. In contrast, a parallel configuration may result in desalination of higher water volume or quantity in a given amount of time.

As can be seen in the example embodiments of FIGS. 4A-4C, the system 400 further includes one or more water inlet pipes or channels 414 and one or more water outlet pipes or channels 416 for intake of saline water and removal of desalinated water and brine. The desalinated water and/or brine may be collected in reservoirs described in the embodiment above. Just as in the previously described embodiments, the system 400 may include a number of valves for water flow reversal, purging, emergency drainage, and water release from the system 400. Each cell 401 further includes a base or bottom wall and a top wall 442 or a lid 444. The base 442, the top 444, or both may be temporarily or permanently attached and/or be selectively removable.

As can be seen from the FIGS. 4A and 4B, the system 400 may include the individual cells 401 connected in series or parallel in a square or a rectangle. Alternatively, the units 401 may be arranged in other configurations such as 1 by 2, 1 by 3, 1 by 4, 2 by 3, 2 by 4, and so on. Different size of the device is contemplated such as a stack of the individual battery cells stacked on top of each other or connected in parallel and/or in series. For example, a single-unit water cleaning electrochemical device that contains many cells in series (i.e., cathode/AEM/anode/AEM/cathode/AEM/cathode, and so on), allowing continuous water flow and step-by-step cleaning within the device is contemplated.

It may be desirable to adjust flow rate as the water proceeds through the system 400 and the concentration of dissolved salts decreases from highly concentrated to low. For example, the water flow may be selectively adjustable within the system 400 between individual cells 401 or groups of cells 401. For example, in the cells 401 located near an inlet 414, the saline water may enter with a predetermined volumetric flow rate Q₁. The flow rate can be gradually or intermittently reduced to Q₂, Q₃, etc., where Q₁>Q₂>Q₃. An example reduction factor may be 2 to 4.

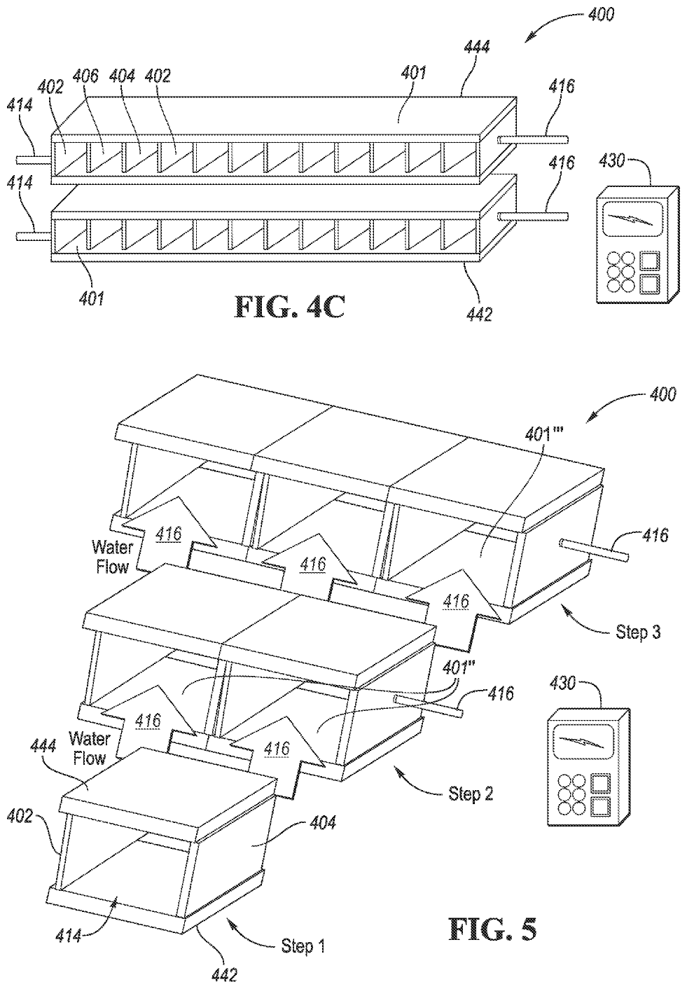

The system 400 may be also stacked in a cascade manner as is depicted in FIG. 5. The term cascade may relate to an arrangement in series or a sequence such that each row contains at least one more cell than the previous row. For example, as is depicted in FIG. 5, the device 400 contains one battery cell 401 in the first row followed by two cells 401″ in the second row, and three cells 401′″ in the third row. The number of rows and cells in each row may differ from the described and depicted example, but each subsequent row should have at least one more cell than a preceding row. If the first row has n number of cells, the subsequent row has at least n+1 number of cells. In another non-limiting example, the number of cells in the second row may be n×2 and each subsequent row may have twice as many cells than the previous row.

Alternatively, the number of cells 401 in the cascade style device 400 may be staggered such that the first row may include n number of cells, the second row may include n+1 number of cells, the third row may again contain n number of cells, etc. Each odd row may contain n number of cells and each even row may have n+1 number of cells. The flow rate in such device may thus decrease and increase, respectively, as the number of cells increases and decreases while the solution proceeds from the inlet 414 towards the outlet 416.

Within the system 400 of FIG. 5, the number of cells 401 increases to accommodate the decreased water flow rates. As the salt concentration decreases from highly concentrated salt water in the first row or in step 1 to highly desalinated water in the following rows such as step 2 and step 3, the water flow rate can be reduced in the subsequent set of cells 401 to maximize water purification performance by increasing the residence time of the treated water within the given cells 401″ and 401′″ of steps 2 and 3, respectively.

The initial flow rate, the decreased flow rates, and the number of cells 401 in the system 400 may vary, depending on a specific application. For example, if the flow rate is reduced by the factor of 2 in step 1 of desalination in cell 401′, the system 400 may have two times more cells 401″ adjacent to the cell 401′, which participate in step 2 of the desalination process. The reduced flow rates allow longer residence time of the water being desalinated within the system 400 such that higher degree of purification may be achieved.

In the device 400, each cell 401 may have its own inlet 414 and/or outlet 416, depending on the type of cell arrangement. Alternatively, the device 400 may feature just one inlet 414 and/or one outlet 416. Alternatively still, the device 400 may feature a plurality of inlets and/or outlets 416 for each cell 401. For example, the device 400, as depicted in FIG. 5, may include an inlet 414 allowing the saline solution in the cell 401′. The cell 401 may have two outlets 416 releasing the desalinated solution into the second row of cells 401″ and at least one more additional outlet 416 releasing the brine solution, for example to a brine solution reservoir (not depicted). Alternatively, the brine solution may be released from a single outlet channel 416 of each row, collecting the brine solution from each cell of the respective row. The outlet channel 416 of each row may connect to a common brine channel leading to a reservoir.

The size of each cell in the system 400 may be the same or different. For example, the first cell 401′ may have the greatest or the smallest dimensions. Alternatively, each cell 401 may have the same dimensions throughout the entire device 400.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A desalination battery cell comprising:
a first compartment separated by an anion exchange membrane from a second compartment, each of the first and second compartments configured to contain a saline water solution having a concentration of dissolved salts c₁ and having first and second intercalation host electrodes, respectively, arranged to be in fluid communication with the solution,
a voltage source configured to supply electric current to the first and second intercalation host electrodes to release cations into the solution; and
a controller programmed to adjust an amount of the electric current being supplied to change direction of anions, present in the solution, passing through the anion exchange membrane between the first and second compartments such that the first and second compartments alternately collect and disperse salt from the solution and the first and second compartments release desalinated water solution having a concentration c₂ of dissolved salts and a brine solution having a concentration c₃ of dissolved salts such that c₃>c₁>c₂.

2. The battery cell of claim 1, wherein each of the first and second intercalation host electrodes include a first and second loading of host material, respectively, and the first loading is different than the first loading.

3. The battery cell of claim 1, further comprising an anion exchange membrane dedicated voltage source.

4. The battery cell of claim 1, further comprising at least one inlet channel and at least one outlet channel per each compartment located between the anion exchange membrane and the intercalation host electrode.

5. The battery cell of claim 1, further comprising a valve configured to prevent flow of a saline water solution to the first or second compartment.

6. The battery cell of claim 1, further comprising an outlet channel and an inlet channel and a first and second reservoir, the second reservoir being connected to the battery via the outlet channel and the inlet channel allowing cycling of the desalinated water solution until a predetermined concentration cₓ of dissolved salts is reached, wherein c₂>cₓ.

7. The battery cell of claim 1, further comprising at least one inlet channel and one outlet channel and wherein the controller is configured to adjust volumetric flow rate in at least one inlet channel, outlet channel, or both.

8. The battery cell of claim 1, further comprising one or more outlet channels and wherein at least one outlet channel has a lower volumetric flow rate than at least one additional outlet channel.

9. A water desalination device comprising:
at least two desalination battery cells, each cell having a first compartment separated by an anion exchange membrane from a second compartment, each of the first and second compartments configured to contain a saline water solution having a concentration of dissolved salts c₁ and having first and second intercalation host electrodes, respectively, arranged to be in fluid communication with the solution,
a voltage source configured to supply electric current to the first and second intercalation host electrodes; and
a controller programmed to adjust an amount of the electric current being supplied from the voltage source to the at least two cells such that the device produces desalinated water solution having a concentration c₂ of dissolved salts and a brine solution having a concentration c₃ of dissolved salts, wherein c₃>c₁>c₂.

10. The desalination device of claim 9, wherein the controller is programmed to control ion transport in each of the at least two cells individually by supplying a different voltage to each of the at least two cells.

11. The desalination device of claim 9, wherein the controller is further programmed to adjust volumetric flow rate of the saline water solution in at least one cell.

12. The desalination device of claim 9, wherein the at least two cells are connected in series.

13. The desalination device of claim 9, wherein the at least two cells are connected in parallel to each other.

14. The desalination device of claim 9, wherein the at least two cells are arranged in a series-parallel configuration.

15. The desalination device of claim 9, wherein the at least two cells include first and second cells, the solution enters the first cell with a predetermined volumetric flow rate Q₁ and the controller is programmed to reduce the volumetric flow rate to a volumetric flow rate Q₂ as the solution proceeds to the second cell such that Q₁>Q₂.

16. A desalination battery device comprising:
a plurality of desalination battery cells arranged in a cascade such that a first row of the cells includes n number of cells, the second row includes at least n+1 number of cells, and each subsequent row includes at least one more cell than a preceding cell row;
a voltage source configured to supply electric current to the plurality of desalination battery cells; and
a controller programmed to control an amount of the electric current being supplied to the cells such that the device produces desalinated water solution having a predetermined concentration c₂ of dissolved salts and a brine solution having a concentration c₃ of dissolved salts, wherein c₃>c₁>c₂.

17. The battery of claim 16, wherein the volumetric water flow rate in the first row is greater than a volumetric flow rate in the second row.

18. The battery of claim 16, wherein the second row includes n×2 number of cells and each subsequent row includes two times more cells than a preceding cell row.

19. The battery of claim 16, wherein each cell has a dedicated outlet.

20. The battery of claim 16, further comprising an anion exchange membrane dedicated voltage source.
